(19) United States
(12) Patent Application Publication
(10) Pub. No.: US 2012/0211426 A1
(43) Pub. Date: Aug. 23, 2012

(54) METHOD AND SYSTEM FOR TREATING A CONTAMINATED FLUID

(76) Inventors: Oronzo Santoro, Fasano (IT); Tiziano Pastore, Martina Franca (IT); Mostafa Moghaddami, Tehran (IR); Mehrdad Raisee, Tehran (IR); Ferdinando Crapulli, Taranto (IT); Domenico Santoro, Fasano (IT)

(21) Appl. No.: 13/230,850

(22) Filed: Sep. 13, 2011

Related U.S. Application Data
(60) Provisional application No. 61/444,115, filed on Feb. 17, 2011.

(51) Int. Cl. C02F 1/28; B01D 21/02; C02F 1/52; C02F 1/72; C02F 1/00; C02F 1/36

(52) U.S. Cl. 210/665; 210/808; 210/748.02; 210/663; 210/668; 210/758; 210/199; 210/97; 210/721; 210/738

(57) ABSTRACT

The present invention provides an integrated method and system for treating a contaminated fluid. The integrated system and method is configured to simultaneously perform multiple functions, for example, transportation, mixing, treatment and separation. The contaminated fluid and treating agents are pumped simultaneously into a processing tank and vigorously mixed by at least one pump-mixer. The at least one pump-mixer is configured to simultaneously perform combined functions such as fluid transportation, rapid and vigorous mixing and treatment. The rapid and vigorous mixing by at least one pump-mixer enhances the processing rates considerably. The contaminants and the disaggregated particles undergo treatment as a result of their reactions with the treating agents. The process residuals, usually in the form of sludge, are separated from the treated fluid. The separation system is also configured to simultaneously perform multiple functions.

### CROSS-REFERENCE TO RELATED APPLICATIONS

The present Utility patent application claims priority benefit of the U.S. provisional application for patent Ser. No. 61/444,115 entitled “INTEGRATED FLUID TREATMENT SYSTEM”, filed on 17, Feb. 2011, under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to fluid treatment. More particularly, the invention relates to an integrated process for fluid treatment.

### BACKGROUND OF THE INVENTION

In conventional fluid treatment plants (FTP), processes and technologies are typically applied in series (e.g., stage by stage) to achieve multiple treatment objectives. For example, fluid treatments such as, but not limited to, coagulation, filtration, disinfection, and advanced oxidation, which can be found typically in drinking water and wastewater treatment plants, are used sequentially to remove organic suspended solids, pathogens, chemical and biochemical oxygen demand, natural organic matter, and other micro and macro pollutants. In coagulation and flocculation processes, aggregation of dispersed and colloidal material is promoted by adding polyvalent cations to form larger-sized flocs, which can eventually be removed by settling or filtration. Disinfection and advanced oxidation are further polishing steps entailing the use of physical or chemical oxidants to inactivate pathogens and/or to destroy persistent micropollutants such as, but not limited to, pharmaceuticals, personal care products and endocrine disrupting compounds.

In all these stages, ad-hoc chemical, biological and physical compounds (e.g. treating agents) are introduced into the contaminated fluid stream separately in a sequential manner while mixing is provided via active (e.g., rotating) or passive (e.g. static) blades. FIG. 1 is a schematic representation of a technique for water or wastewater treatment, in accordance with the prior art. In this representation, the typical sequential processes for contaminated fluid treatment are shown. Untreated fluid 101 is introduced into a flocculation stage 110 using a pump 102. Once fluid 101 is loaded into a rapid-mix vessel 113, a coagulant 111 is added to fluid 101 using a metering pump or by gravity, and then mixed in rapid-mix vessel 113 using large rotating blades 112. Fluid 101 is then directed, either by gravity or through other pumps, to a flocculation tank 114 where mild agitation conditions are created to promote floc formation. Flocs, in the form of sludge, are then separated in a settling tank 115, and flocculated sludge 116 is periodically withdrawn from the bottom of tank 115 and properly treated and/or disposed.

The flocculation stage 110 can be followed or enhanced by the addition of an absorbent 121 in a coagulation stage 120 if further treatment is required. Similarly as for flocculation stage 110, adsorbent 121 is added to fluid 103 and then properly mixed in a rapid mix vessel 123, for example, using rotating blades 122. Fluid 103 mixed with adsorbent 121 then enters a settling tank 124 that separates the exhausted absorbent 121 from treated water 104 while generating sludge 126, which is finally drained from the bottom of a second settling tank 125.

When the microbial or micropollutant contamination exiting the coagulation, flocculation and absorption stages still exceeds the maximum allowed concentration, treated water 104 is subjected to further treatment such as a disinfection/advanced oxidation stage 130, a process meant to remove disease-causing organisms and potentially toxic or carcinogenic micropollutants from the fluid stream. Thus, a disinfectant and/or oxidant 131 is delivered to treated water 104 via a metering device and then mixed to ensure proper dispersion with a mixing device such as a rotating blades portion 132 in a rapid mixing zone 133. Once disinfectant and/or oxidant 131 is/are properly dispersed in treated water 104, a contact tank 134 allows the pathogens/micropollutants to accumulate the needed dose and contact time for inactivation/oxidation.

Finally, a treated fluid 105 can be supplied for drinking purposes, discharged into a receiving body (e.g., a lake, the soil, an ocean, etc.) or reused for agricultural, industrial or recreational purposes. As clearly shown in FIG. 1, this treatment scheme is made of several processes in series and contains several sequential stages. As a result, various technologies are needed, and various treating agents are injected in sequence in order to promote and complete the treatment. Even when simplified treatment schemes are considered (e.g. treatment schemes where some of the treatment stages shown in FIG. 1 are omitted), these processes are still energy and footprint intensive, as the stages requires specific pumps and mixers to move the fluid from one stage to the next as well as to effectively disperse the treating agents into the contaminated fluid in the various stages.

In fluid treatment applications, mixing is often needed in order to enhance treatment performance and efficiency. As an example, effective rapid mixing generally ensures the fluid particles comes into contact with the injected treating agents for the designated time such that purification reactions get initiated and occur over time. It is well documented the lack of mixing is responsible for diffusion-limited or incomplete reactions, known as one of the main causes of treatment inefficiency and undesired byproduct formation in chemical reactor engineering. Therefore, proper rapid mixing leads to maximization of process efficiency and minimization of treatment time (and cost) for a given treatment objective. It is equally relevant that a reactor is designed in a way that the contact time experienced by a parcel of fluid is as uniform as possible, which would lead to a maximization of process efficiency and minimization of treating agents' usage and undesired byproduct formation. It is therefore an objective of the present invention to provide an effective, fully controllable, modular and integrated mixing/treatment means for the purification of a contaminated fluid.

Mixing and treatment operations often are complex and multi-faceted. They can involve single-phase liquid mixing/treatment as well as multiphase mixing/treatment (liquid-liquid mixing, solid-liquid mixing, gas-liquid mixing, and, in some cases, three-phase mixing involving solids, liquids and gases).

Among various methods to promote mixing between treating agents and the contaminated fluid, the use of rotating blades in a mixing tank is probably the oldest and most widely used for fluid treatment. A primary function of such mixing vessels is to provide adequate stirring in vessels of various shapes and sizes. Baffles may or may not be incorporated in the vessels to break up the vortex and also to prevent solid-body rotation of the fluid. Pipes are appropriately located in the vessel to load and unload the fluid. Dip tubes are often employed to inject chemicals and fluids at specific locations. The type of rotating blades employed depends on the type of the vessel and the process objective.

One example of a currently known mixing tank comprises a vessel and two special blades that help produce a large mixing zone which, after adequate time, provides a thorough blending of such liquids.

Another current means of providing mixing is a mixing nozzle apparatus. In this mixing means, a polymer is introduced using special nozzles into a flowing fluid stream to produce a resultant thickened mixture for application in fire extinction. In the fluid mixing nozzle apparatus, two fluids enter into a relatively large vessel and exit through a convergence-divergence channel. The device provides a fluids mixing nozzle that is capable of mixing and atomizing fluids at low pressures. The use of such nozzles may generate substantial hydraulic head losses, and in many high flow-rate applications the hydraulic head losses are highly undesirable.

The use of elbow pipe to enhance mixing has also been previously exploited. More specifically, a fluid mixer apparatus for mixing a carrier liquid such as water with the second liquid substance can be made in the form of an elbow pipe interconnecting the carrier liquid inlet with a discharge pipe. The second liquid is introduced into the fluid stream of the carrier liquid at a point on the outer radius of the elbow where the high velocity stream of carrier liquid impinges upon the side of the elbow pipe to cause the second liquid to be impinged upon by the carrier stream at the point of its highest velocity to impart maximum shear to the agent liquid, thus ensuring maximum mixing of two liquids in the discharge pipe. Since the generated shear rates in the elbow are not significantly high and typically are not considered to be highly anisotropic, this method tends to not produce a uniform mixture. To further enhance mixing performance, more than one mixing elbow may be employed. In an assembly of pipe elbows for mixing and transporting substances along an assembly, assemblies of three pipe elbows are connected successively. Elbow assemblies have an inlet and an outlet disposed in parallel planes and axially offset from one another. The pipe elbows associated with a group have centerlines disposed in mutually perpendicular planes to cause the mixture to rotate as it travels along the pipe elbows.

In some processes (such as sulfuric or hydrofluoric acid alkylation of hydrocarbons), it is helpful that two fluids are mixed together before they come in contact with a third fluid. This can be achieved by an apparatus comprising an inner and outer tube concentrically arranged to form an injection nozzle, which itself is placed within a circulating conduit. The inner tube and the outer tube have ports located on their sidewalls to allow the passage of a fluid through the first tube and into the second tube forming a mixture that leaves the outer tube through ports thereon and enters a circulation vessel. As a result of the many small ports in this system, the pressure drop is large and the system may not be ideal for accommodating large flow rates.

A mixing device to increase the mixing efficiency is an enhanced-mixing corrugated jet pump. A corrugated jet pump incorporates a corrugated annular nozzle o-give that, during pumping operations, creates alternating low and high velocity zones in the o-give of the nozzle. These different velocity zones propagate shear planes that enhance the jet pumps downstream of the mixing. At the same time, the core of the corrugated annular nozzle ring creates alternating vortices in the low and high energy fluids, which also enhances mixing. Two vortices per crown region are generated. These vortices, or swirling actions, partially enhance the jet pump's mixing action.

Another method for mixing fluids uses a pin-based mixing pump. In this method, pins are placed to extend inwardly from a cylindrical housing and outwardly from a coaxial rotor shaft in intermeshing fashion. The pins are generally cylindrical in shape except for a set of half cylindrical pins on the rotor shaft designated for pumping of materials through the housing device. Flow through-put is further enhanced by a set of axially positioned vanes extending from the housing inwardly toward the rotor shaft with curved ends forming a scoop to receive materials being given a rotary flow component about the shaft by its rotation and convert the flow direction to an axial flow path.

Yet another prior art means for mixing fluids describes a mixing pump for pumping fluid from a reservoir with means for injecting additional fluids into the fluid stream on the suction side of the pump and on the discharge side of the pump. The fluids that are injected on the suction side of the pump are mixed with the fluid from the reservoir as these fluids pass through the impeller of the pump. The mixing pump provides effective mixing of the fluids. However, the injection means introduce the injected fluids into the fluid stream at once near the same location and do not enable fluids to be injected and mixed into the fluid stream in a prescribed sequence, and is helpful or needed in some fluid treatment systems. Also, in the present mixing means, the injection means are placed between the inlet and the pump impeller. This causes some of the fluids being injected to potentially escape through the inlet to contaminate the reservoir, and is undesirable in some treatment processes such as, but not limited to, chemigation. In addition, the inlet of the pump is a bell or scoop that is inserted into a tank or reservoir, which provides little flexibility when using these mixing means in fluid treatment systems as it may be difficult to incorporate a tank or reservoir into some systems. Furthermore, the pump has a fixed number of injectors, which also restricts the flexibility of this mixing means. From a mixing/treatment standpoint, the flexibility of the present means is further restricted by the fixed rotational speed of the pump, which would not allow controllable shear rate, mixing gradient, contact time and delivered treating agent dose. Furthermore, such mixing means does not contemplate the use of a catalytic material on the pump body which can promote reactions given the high mixing gradient generated by the pump rotor. Lastly, the mixing means described above would not allow a stage integration between the pumping operation, the treatment and the subsequent separation stage (such as, but not limited to, a pressurize filter) if present.

The chemical induction flash mixers represent another example of prior art. Although such mixing means do enhance mixing and the diffusion of the treating agent into the bulk fluid, it does not allow a full integration of the mixing and treatment stages. Also, it does not enable a precise control of the mixing gradient, gradient dose and contact time as the rotor speed may not be operated at variable speed. The chemical induction flash mixers are not usually suitable to provide a positive head pressure the fluid and are not suitable as multiple arrays of mixers in series or in parallel. As such, they are not typically effective as a means to control the mixing gradient and the contact time.

In view of the foregoing, there is a need for improved techniques for providing a more efficient, adaptable and integrated mixing/treatment method consisting of an effective mixing system and a processing tank unit for the treatment of a contaminated fluid that uses solid, gaseous or liquid treating agents.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic representation of a technique for water or wastewater treatment, in accordance with the prior art;

FIG. 2 shows an exemplary sequence of the mode of action of a high-energy pump-mixer, in accordance with an embodiment of the present invention;

FIGS. 3A and 3B are schematic representations of exemplary integrated fluid treatment systems, in accordance with two embodiments of the present invention.

FIG. 3A illustrates a system comprising a processing tank, and FIG. 3B illustrates a system comprising a granular media filtration unit;

FIG. 4 is a schematic representation of an exemplary integrated stage of a fluid treatment system comprising piping, injectors and a pump-mixer, in accordance with an embodiment of the present invention;

FIGS. 5A and 5B illustrate an exemplary pump-mixer, in accordance with an embodiment of the present invention. FIG. 5A is a transparent side view, and FIG. 5B is a diagrammatic front view;

FIG. 6 illustrates a diagrammatic side view of an exemplary injector from a fluid treatment system, in accordance with an embodiment of the present invention;

FIGS. 7A-7(F), show the flow of material through exemplary processing tanks with separation and treatment combined in one unit, in accordance with an embodiment of the present invention; FIG. 7A shows the horizontally uniform inclined plates lamella, FIG. 7B shows horizontally non-uniform coarse to fine inclined plates, FIG. 7C shows horizontally non-uniform fine to coarse inclined plates, FIG. 7D shows vertically non-uniform fine to coarse inclined plates, FIG. 7E shows vertically non-uniform coarse to fine inclined plates and FIG. 7F shows sherwood plates lamella;

FIG. 8 shows an exemplary hydraulic configuration for an integrated treatment system where two pump-mixers and two injection modules are used in parallel, in accordance with an embodiment of the present invention;

FIG. 9 illustrates an exemplary hydraulic configuration for an integrated treatment system where two pump-mixers, two injection modules and two processing tanks are used in series, in accordance with an embodiment of the present invention;

FIG. 10 illustrates an exemplary hydraulic configuration for an integrated treatment system where two pump-mixers and two injection modules are used in series, in accordance with an embodiment of the present invention;

FIG. 11 illustrates an exemplary use of an integrated fluid treatment system where two pump-mixers and one injection module are used in series, in accordance with an embodiment of the present invention;

FIG. 12 is a chart showing exemplary averaged velocity gradients (G parameter) for different rotational speeds of a pump-mixer from an exemplary integrated fluid treatment system, in accordance with an embodiment of the present invention;

FIG. 13 is a graph showing exemplary effects of the rotational speed of a pump-mixer on the coagulant dose in an exemplary integrated fluid treatment system, in accordance with an embodiment of the present invention;

FIG. 14 is a graph showing exemplary effects of the rotational speed of a pump-mixer on the adsorbent dose in an exemplary integrated fluid treatment system, in accordance with an embodiment of the present invention;

FIG. 15 is a graph showing exemplary effects of the rotational speed of a pump-mixer on the disinfectant dose in an exemplary integrated fluid treatment system, in accordance with an embodiment of the present invention;

FIG. 16 is a schematic representation of an exemplary pilot plant, in accordance with an embodiment of the present invention;

FIG. 17 illustrates the chemical oxygen demand (COD) removal obtained in tested experimental trials of the pilot plant illustrated by way of example in FIG. 16, in accordance with an embodiment of the present invention;

FIG. 18 displays the coliform inactivation obtained in tested experimental trials of the pilot plant illustrated by way of example in FIG. 16, in accordance with an embodiment of the present invention;

FIG. 19 shows the sludge production obtained in tested experimental trials of the pilot plant illustrated by way of example in FIG. 16, in accordance with an embodiment of the present invention; and

FIG. 20 shows changes in dissolved gas concentration obtained in tested experimental trials of the pilot plant when a gaseous treating agent is injected in the contaminated fluid, illustrated by way of example in FIG. 16, in accordance with an embodiment of the present invention.

Unless otherwise indicated illustrations in the figures are not necessarily drawn to scale.

### SUMMARY OF THE INVENTION

To achieve the forgoing and other objectives and in accordance with the purpose of the present invention, an integrated method and system for treating contaminated fluids is presented. It is to be understood that the present invention is not limited to the particular methodology, compounds, materials, manufacturing techniques, uses, and applications, described herein, as these may vary. It is to be understood that the terminology used herein is used for the purpose of describing particular embodiments only, and is not intended to limit the scope of the present invention.

In one embodiment of the present invention, an integrated method for an exemplary sequence of the mode of action of a at least one pump-mixer comprises the steps of transferring and mixing, simultaneously, the contaminated fluid containing gaseous, solid or liquid contaminants, possibly having large clusters of particles, and treating agents/compositions in a processing tank. Furthermore, treating agents may be dispensed/injected into the body of at least one pump-mixer associated with the suction stream of the contaminated fluid in the suction pipe. A rapid and vigorous mixing is provided by the at least one pump-mixer. Such rapid and vigorous mixing enhances the treating agents' processing rates and it disassociates/disaggregates the large cluster of particles, if present in the contaminated fluid, into smaller size particles, thus making the contaminated fluid prawn to treatment. The process residuals originated by the treatment, usually in the form of “sludge”, are then separated from the treated fluid. If catalytic or oxidative processes are promoted, rapid and vigorous mixing of treating agents within the contaminated fluid are instrumental in substantially enhancing such processing rates, for example by improving the efficiency of diffusion-limited reaction kinetics such as, but not limited to, the ones of oxidative or catalytic processes promoted by the treating agents.

In another embodiment of the present invention, a method for an exemplary sequence of the mode of action of an at least one pump-mixer comprises the steps of incorporating an ultrasonic treatment mechanism to the integrated process for treating the contaminated fluid, in-conjunction with an at least one pump-mixer. Incorporating an ultrasonic treatment mechanism to the process unit for treating the contaminated fluid may substantially improve the reaction and processing rates of the treating agents and consequently achieving relatively rapid reaction kinetics such as, but not limited to, the ones of catalytic and oxidative processes promoted by treating agents to further improve the overall efficiency of the foregoing integrated process.

In another embodiment of the present invention, a method for an exemplary sequence of the mode of action of a at least one pump-mixer comprises the steps of configuring a heating mechanism such as, but not limited to, microwaves, heating coils, or super heated stream to heat the contaminated fluid admixed with treating agents, to a predetermined range of temperature, to achieve, relatively rapid and improved reaction kinetics such as, but not limited to, the ones of catalytic processes caused by treating agents.

In another embodiment of the present invention, a method for an exemplary sequence of the mode of action of an at least one pump-mixer comprises the steps of incorporating an electromagnetic/electrostatic treatment mechanism for treating the contaminated fluid in conjunction with an at least one pump-mixer. Incorporating an electromagnetic/electrostatic treatment mechanism to the process unit for treating the contaminated fluid may substantially improve the reaction and processing rates and, consequently, the system efficiency by achieving relatively rapid reaction kinetics such as, but not limited to, the ones of oxidative and/or catalytic processes performed by treating agents, which further improve the overall efficiency of the foregoing integrated process.

The heating mechanism, in-conjunction with the high-frequency ultrasound mechanism and the electromagnetic/electrostatic mechanism, and the at least one pump-mixer may further substantially improve the overall reaction and processing rates and efficiency of the foregoing process for treating the contaminated fluids.

In another embodiment of the present invention, a method for an exemplary sequence of the mode of action of an at least one pump-mixer comprises the steps of configuring an at least one pump-mixer to an least one processing tank functioning as a “circulation” pump-mixer, to achieve rapid and vigorous mixing of the contaminated fluid admixed with treating agents may enhance reaction kinetics such as, but not limited to, the ones of catalytic and oxidative processes promoted by treating agents. It is to be noted that configuring an at least one pump-mixer to an least one processing tank functioning as a circulation pump-mixer may provide relatively uniform mixing for the contaminated fluid admixed with treating agents and also for a slurry phase contaminated fluid as well.

In another modified embodiment of the present invention, a method for an exemplary sequence of the mode of action of a at least one pump-mixer, comprising the steps of conducting the integrated fluid treatment process with or without the dispensing/injection stage, for example, but not limited to, when the treating agents are dispensed/injected using metering pumps, or when the injectors are located directly on the body of the at least one pump-mixer, which may be a suction pipe removably connected to the at least one pump-mixer.

In another embodiment of the present invention, a method for an exemplary sequence of the mode of action of an at least one pump-mixer comprises the steps of increasing the overall processing efficiencies by limiting the anti-synergistic actions between treating agents. This is achieved by the rapid mixing mode of action of the at least one pump-mixer which enables an instantaneous dispersion of the treating agents with the contaminated fluid. It is to be emphasized that the rapid mixing, generally, prevents the treating agents from coming into contact with each other prior to being dispersed in the matrix of the contaminated fluid. For example, without limitation, it is known to those skilled in the art that activated carbon quenches oxidants such as hydrogen peroxide and chlorine, however its quenching rate depends on the activated carbon and oxidant local concentrations; notably, such a quenching rate can be significantly reduced by lowering their concentrations by dilution/dispersion with the contaminated fluid using substantially rapid mixing

In another embodiment of the present invention, the system comprises a treatment unit. The treatment unit further comprises at least one pump-mixer unit having an at least one at least one pump-mixer. The at least one pump-mixer performs multiple functions, for example, but not limited to, a means for transferring the contaminated fluid admixed with treating agents, a means for rapid and vigorous mixing mode and a means for providing positive head pressure to the contaminated fluid. The rapid and vigorous mixing mode is used by the at least one pump-mixer for desegregating/disassociating large clusters of particles into smaller size particles present in the contaminated fluid, which ultimately allows the rapid penetration of the treating agents into the particle core thus preventing process inefficiency due to presence of particle-associated contaminants and their diffusion-limited reaction kinetics.

In another embodiment of the present invention, the treatment unit may further be equipped with at least one injector for delivering, either simultaneously or in a prescribed sequence, the liquid, solid or gaseous treating agents into the contaminated fluid to be treated.

In another embodiment of the present invention, the treatment unit may further be equipped with a processing tank having the dual function of treatment and separation unit such as, but not limited to, a clarifier, with or without internal surfaces such as, but not limited to, lamellas to streamline/direct the fluid, configured to simultaneously promote an enhanced separation of a gaseous and/or solid phase from the liquid by providing surface friction and/or advanced treatment (such as, but not limited to, coagulation/absorption/disinfection/oxidation) by generally ensuring that parcels of contaminated fluid (e.g., liquid, gaseous or solid component) receive the same treating agent dose and contact time.

In another embodiment of the present invention, the treatment unit may further be configured with a granular, polymeric or ceramic filter with pore size ranging from millimeters (e.g., sand or anthracite filters) to nanometers (e.g., nano-filtration membranes) to further substantially enhance gaseous, liquid or solid particles separation, advanced treatment (such as, but not limited to, coagulation/absorption/disinfection/oxidation), and the removal of process residuals including, but not limited to, excess sludge and byproducts.

In another embodiment of the present invention, the treatment unit may also be equipped with at least one at least one pump-mixer to break down the contaminated solid, gaseous and liquid particles, potentially present into the contaminated fluid, into relatively, smaller size particles while simultaneously delivering gaseous, liquid or solid treating agents into the particle cores.

In another embodiment of the present invention, the treatment unit may also be equipped with one or more at least one pump-mixers, either connected in series or in parallel for simultaneously providing positive head pressure, and at least one uniform mixing of the contaminated fluid.

In another embodiment of the present invention, the treatment unit may be configured with at least one heating mechanism such as, but not limited to, microwaves, heating coils or super heated steam for heating the contaminated fluid in-conjunction with treating agents, to a predetermined temperature range, to achieve the rapid reaction kinetics such as, but not limited to, the ones of catalytic processes performed by treating agents to further improve the overall processing efficiency for treating the contaminated fluid.

In another embodiment of the present invention, the treatment unit may be configured with one or more high-frequency ultrasonic mechanisms to facilitate an integrated mixing of the contaminated fluid, and to achieve the rapid reaction kinetics such as, but not limited to, the ones of catalytic processes performed by treating agents to further substantially improve the overall processing efficiency for treating the contaminated fluid.

In another embodiment of the present invention, the treatment unit may be configured with an electromagnetic/electrostatic treatment mechanism for enhancing the processing rate of the contaminated fluid, as well as to facilitate the separation between the process residuals and the purified fluid.

In another embodiment of the present invention, a system for an exemplary sequence of the mode of action for the at least one pump-mixer may be configured to implement simultaneous application of conflicting treating agents, since the rapid mixing promoted by the at least one at least one pump-mixer substantially increases the overall efficiency of the process due to limitation of the anti-synergistic actions of the treating agents. The rapid mixing, generally, prevents the treating agents form coming into contact with each other before they are dispersed in the contaminated fluid. For example, without limitation, it is known to those skilled in the art that activated carbon quenches oxidants such as hydrogen peroxide and chlorine, however its quenching rate depends on the activated carbon and oxidant local concentrations; notably, such a rate can be significantly reduced by lowering their concentrations by dilution with the contaminated fluid using substantially rapid mixing.

In another embodiment of the present invention, the integrated method and system for fluid treatment may be used as a pre-treatment to improve the ability for treatment of subsequent processes such as, but not limited to, the ones carried out in mechanical, physical, biological and chemical processing units.

In another embodiment of the present invention, the integrated method and system for fluid treatment system may be used as a post-treatment of effluents exiting previous treatment stages such as, but not limited to, the ones carried out in mechanical, physical, biological and chemical processing units.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

An embodiment of the present invention and at least one variation thereof provides an integrated treatment system to purify an untreated or contaminated fluid. Some embodiments comprise a treatment unit with a dual function pump and rapid mixer unit (e.g., pump-mixer) formed by one or more pumps acting as a high-energy mixer and a number of injectors that deliver, either simultaneously or in a prescribed sequence, the liquid, solid or gaseous treating agents into a fluid to be treated. Some embodiments may incorporate a treatment unit with a dual function separation and processing tank such as, but not limited to, a clarifier, with or without internal surfaces such as, but not limited to, lamellas to streamline/direct the fluid, meant to simultaneously promote enhanced separation by providing surface friction and/or advanced treatment (such as, but not limited to, coagulation/absorption/disinfection/oxidation) by generally ensuring that liquid, gaseous or solid particle receive the same treating agent dose and contact time. Some embodiments use a granular, polymeric or ceramic filter with pore sizes ranging from millimeters (e.g., sand or anthracite filters) to nanometers (e.g., nanofiltration membranes) to further enhance gaseous, liquid or solid particles separation, coagulation/absorption/disinfection/oxidation as well as the removal of process residuals including, but not limited to, excess sludge and byproducts. Some embodiments comprise one or more pumps acting as high-energy mixers to break up the contaminated solid, gaseous and liquid particles into smaller ones while simultaneously delivering a gaseous, liquid or solid treating agent into the particle cores, thus allowing the treatment of challenging multiphase fluids such as, but not limited to, combined sewer overflow, raw effluents and sludge. Some embodiments comprise a system made of one or more pumps connected in series or in parallel able to simultaneously provide positive head pressure, high-energy mixing and milling to the constituents of an untreated or contaminated fluid. In some of these embodiments, the system functions without the use of injection or metering pumps.

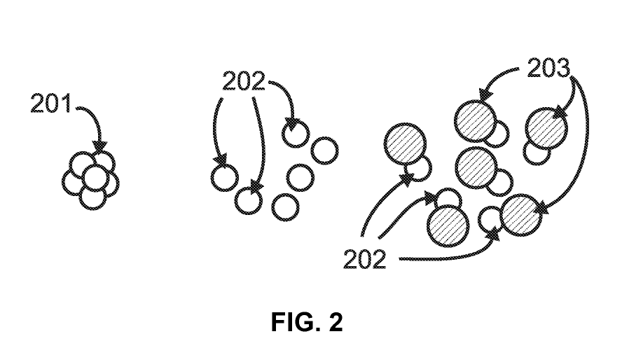

FIG. 2 shows an exemplary sequence of the mode of action of a high-energy pump-mixer, in accordance with an embodiment of the present invention. First, the fluid containing contaminated gaseous, solid or liquid contaminants embedded in a particles portion 201 are disaggregated into smaller sized particles denoted as a disaggregated particles portion 202 by a high-energy mixing pump. Then a treating agents portion 203 is injected into the fluid and vigorously mixed with the disaggregated particles portion 202 such that the targets of disaggregated particles portion 202 are reached and appropriate reactions may occur. As a non-limiting example, treating agents portion 203 may be a solid, gas or liquid.

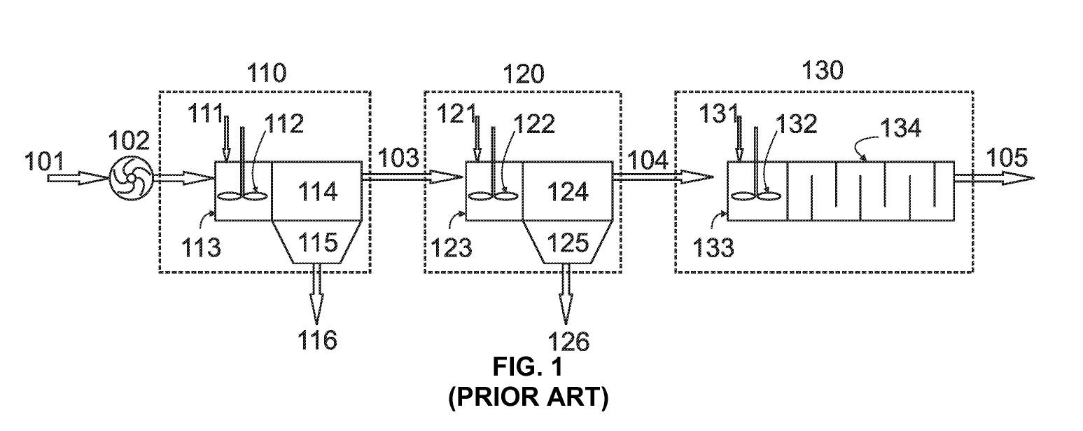

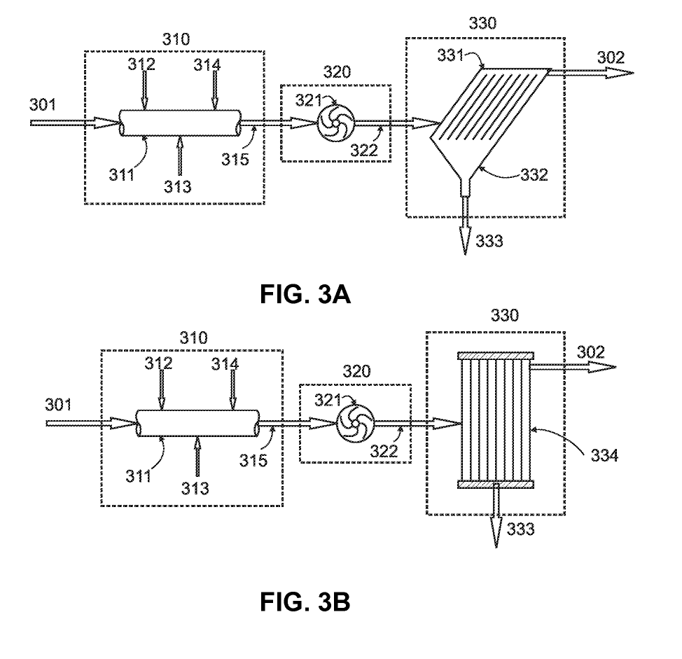

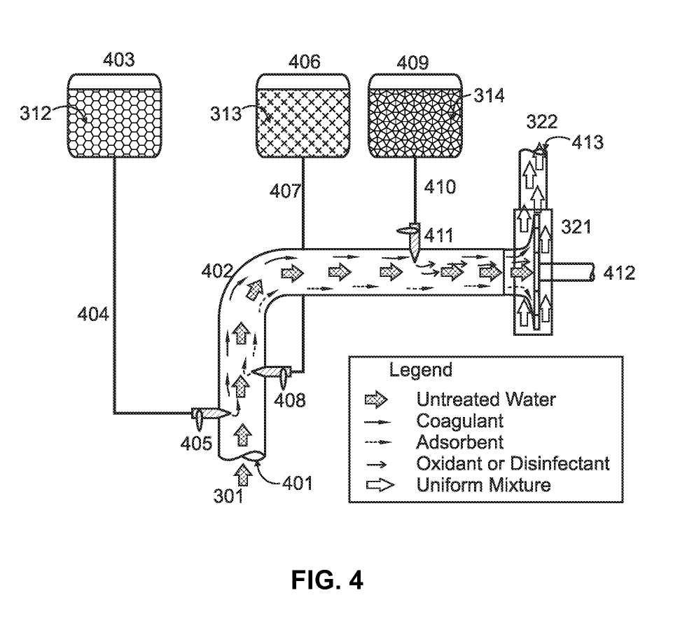

FIGS. 3A and 3B are schematic representations of exemplary integrated fluid treatment systems, in accordance with embodiments of the present invention. In a modified embodiment, the integrated treatment system can also operate without a separation stage. This is the case, for example, but not limited to, of a system used for operating in disinfection and oxidation mode where homogeneous (e.g. liquid phase) processes occur and no process residuals are formed. In another modified embodiment, the integrated fluid treatment may not require the injection module for example when the treating agents are delivered using metering pumps or when the injectors are located directly on the body of pump. FIG. 3A illustrates a system comprising a processing tank 331, and FIG. 3B illustrates a system comprising a granular media filtration unit 334. Referring to FIG. 3A, the present embodiment uses stage integration to combine pumping and mixing in a rapid mixing unit 320 equipped with a number of injectors in an injection stage 310 to deliver treating agents, followed by separation, disinfection and oxidation integrated in a coagulation/adsorption/oxidation unit 330 to aid in making the fluid treatment process more efficient and more cost effective than current methods which employ several processes in series, as shown by way of example in FIG. 1. An untreated fluid 301 enters injection stage 310 via a suction pipe 311. Furthermore, suction pipe 311 is connected to a fluid pump 321. The present embodiment differentiates from prior art approaches at least in that the contaminated fluid can be introduced to the mixing/treatment via existing pipes or pumps (therefore the present embodiment does not necessarily require an intermediate reservoir). This is, for example, the case of municipal wastewater exiting membrane reactors (MR) as the membrane modules may deliver a MR-treated fluid already pressurized in pipes and, as such, could be directly transferred to the subsequent disclosed integrated treatment system without the use of any intermediate reservoirs. The liquid, gaseous or solid treating agents for the treatment process such as, but not limited to, a coagulant 312, an adsorbent 313 and an oxidant or disinfectant 314 are introduced into suction pipe 311. These treating agents may be introduced into suction pipe 311 one by one, as in the present embodiment or may be premixed before entering the suction pipe. A mixture 315 of treating agents, coagulant 312, adsorbent 313, oxidant or disinfectant 314 and untreated fluid 301, then flows into rapid mixing unit 320. Fluid pump 321 primarily performs two different tasks. Fluid pump 321 is firstly used to provide mixture 315 with the needed energy for moving into coagulation/adsorption/oxidation unit 330 and further on into downstream units if needed; fluid pump 321 also provides a high mixing gradient (e.g. high level of mixing), thus generally ensuring the uniform dispersion of treating agents, coagulant 312, adsorbent 313 and oxidant or disinfectant 314, into untreated fluid 301, even in the case of challenging viscous fluids with fast reaction kinetics. Once mixed, a mixture 322 exits fluid pump 321 and enters integrated coagulation/adsorption/oxidation unit 330. In coagulation/adsorption/oxidation unit 330, treatment processes (i.e., coagulation, adsorption and oxidation) are completed in a parallel fashion in single-stage processing tank 331. The process residuals of the different processes are separated via enhanced settling in a settling hopper 332, and combination of the residuals as a sludge 333 is drained from the bottom of settling hopper 332. Finally, a treated fluid 302 exits the treatment system. In some embodiments, the internal cavities of the systems such as, but not limited to, the interior portion of fluid pump 321 and processing tank 331, can be used as a support for coating catalytic material and/or for anchoring catalytic materials structured on surfaces or filling bodies such as, but not limited to, titanium dioxide, titanomagnetite or zerovalent iron to promote oxidative and/or catalytic reactions as a variance of, or as an addition to, the disinfection/oxidation step and provide advanced treatment to the contaminated fluid.

In some embodiments of the present invention, a method for an exemplary sequence of the mode of action of an at least one pump-mixer comprises the steps of incorporating an ultrasonic treatment mechanism to the integrated process for treating the contaminated fluid in-conjunction with an at least one pump-mixer. Incorporating an ultrasonic treatment mechanism to the process unit for treating the contaminated fluid may substantially, improve the reaction rate of the treating agents and consequently, achieving relatively rapid reaction kinetics such as, but not limited to, the ones of oxidative and/or catalytic processes performed by treating agents to further improve the overall efficiency of the foregoing integrated process.

In another embodiment of the present invention, a method for an exemplary sequence of the mode of action of a at least one pump-mixer comprises the steps of configuring a heating mechanism such as, but not limited to, heating coils, or superheated stream to heat the contaminated fluid admixed with treating agents, to a predetermined range of temperature, to achieve, relatively rapid and improved reaction kinetics such as, but not limited to, the ones of oxidative and/or catalytic processes caused by treating agents.

In another embodiment of the present invention, a method for an exemplary sequence of the mode of action of a at least one pump-mixer comprises the steps of configuring an electromagnetic/electrostatic mechanism such as, but not limited to, an illuminating device, magnetic separators, or electroseparators to enhance the oxidative and/or catalytic processing rates occurring in the contaminated fluid admixed with treating agents, as well as to provide a predetermined range of activation energy to fluid admixed with the catalyst.

The combination of heating mechanism, the high-frequency ultrasound mechanism and the electromagnetic/electrostatic mechanism, and the at least one pump-mixer may further substantially improve the overall efficiency of the foregoing process for treating the contaminated fluids.

Referring to FIG. 3B, an alternative scheme for separation of particles from the fluid is shown where the single-stage processing tank is replaced with granular media filtration unit 334. Those skilled in the art, in light of the present teachings, will readily recognize that various different types of filtration units may be used such as, but not limited to, granular media filtration units, polymeric membrane units, ceramic membrane units, etc. In an alternate embodiment a filtration unit may follow a processing tank. In the present embodiment, injection stage 310 and rapid mixing unit 320 are the same as those described by way of example above in FIG. 3A. However, mixture 322 enters granular media filtration unit 334 to separate sludge 333 from treated fluid 302.

In some embodiments, process residuals in the form of sludge 333 containing exhausted treating agents (coagulation/adsorption/oxidation) may be recycled upstream (either as they are or after appropriate treatment) to one of the injection modules using an injector located on the injection stage 310. In some other embodiments, a portion of mixture 322, treated fluid 302 or sludge 333 can be recycled upstream to one of the injection modules via the set of injectors in injection stage 310 to allow further treatment, either using metering pumps or exploiting the suction conditions generated by fluid pump 321 and the set of injectors, and are typically employed to deliver fresh treating agents to the system.

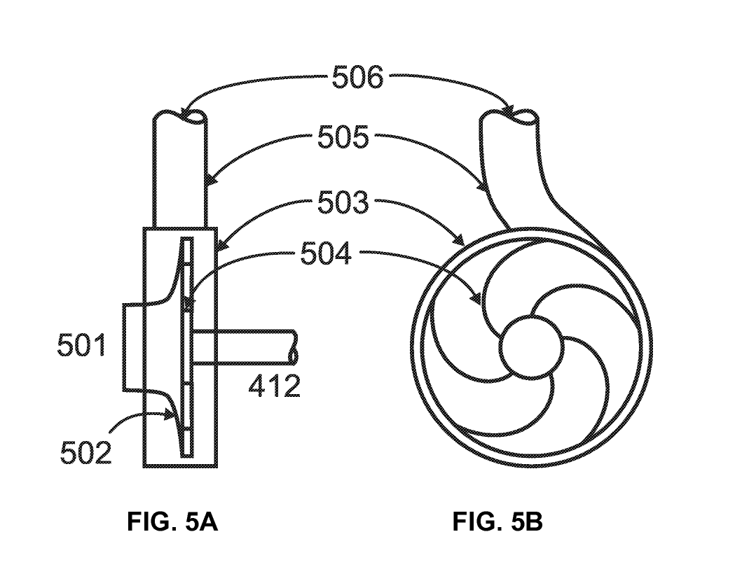

FIG. 4 is a schematic representation of an exemplary integrated stage of a fluid treatment system comprising injectors, mixers and fluid pump 321, in accordance with an embodiment of the present invention. In the present embodiment, a contaminated fluid 301 enters an injection pipe 402 at an inlet location 401. In case the integrated treatment system of the present embodiment is employed to retrofit existing water treatment plant, the fluid could be introduced to the treatment using existing piping, pumps and/or gravity fed from clearwells. Several injection ports are located on injection pipe 402. In alternative embodiments, the injection ports may be located on the body of fluid pump 321 or, some treating agents can be pre-mixed off-line and delivered as one product using a single injector. Alternate embodiments of the present invention may comprise more or fewer injectors to suit the needs of a particular system. In addition, some embodiments may enable injectors to be added or removed to enable the system to adapt to any changing requirements. In the present embodiment, coagulant 312, that is stored in a coagulant reservoir 403, moves through a capillary tube 404 to a coagulant injector 405, which may or may not be assisted by a metering pump. Similarly, adsorbent 313 flows through a capillary tube 407 from an adsorbent reservoir 406 to an injector 408. Finally, oxidant or disinfectant 314, that is stored in a reservoir 409, moves through a capillary tube 410 and is injected via a disinfectant/oxidant injector 411. In the present embodiment, coagulant 312, adsorbent 313 and oxidant or disinfectant 314 are injected at different points along injection pipe 402; however, in alternate embodiments, the injectors may be located in the same area of the injection pipe or some treating agents such as, but not limited to, the coagulant and adsorbent may be first premixed in a reservoir and injected from a single injector into the untreated fluid. In the present embodiment, the inhomogeneous mixture made by untreated fluid 301, coagulant 312, adsorbent 313 and oxidant or disinfectant 314, or any possible combination of these treating agents, flows towards fluid pump 321 through injection pipe 402. Fluid pump 321, connected to an electrical motor (not shown) by a connecting shaft 412, generates high shear stresses in the fluid flow that lead to effective mixing of the treating agents with untreated fluid 301. A homogeneous mixture 322 exits an outlet 413 of fluid pump 321 and is directed to a processing tank for further treatment such as, but not limited to, a settling/disinfection.portion.

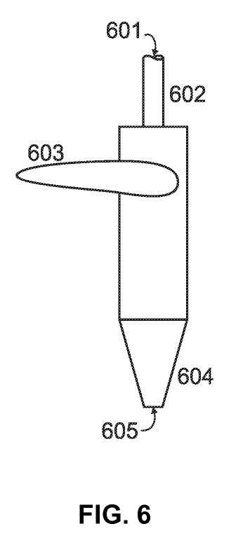

FIGS. 5A and 5B illustrate an exemplary mixing pump, in accordance with an embodiment of the present invention. FIG. 5A is a transparent side view, and FIG. 5B is a diagrammatic front view. In the present embodiment, fluid enters a pump eye 501 and is sucked into a pump propeller 502. A blades portion 504 in pump propeller 502 force the fluid to rotate quickly and to generate high shear rates in the fluid flow. These shear rates mix the treating agents and untreated fluid. Then, the fluid exits pump propeller 502 and enters a pump housing 503. Since pump propeller 502 rotates at a fast angular velocity and pump housing 503 is stationary, shear rates are generated by pump housing 503 as well. Shear rates can be controlled in several ways, for example, without limitation, by varying the pump type, flow rate and speed, by optimizing the gap between pump propeller 502 and pump housing 503, by using corrugated materials, etc. Decreasing the gap between pump propeller 502 and pump housing 503 also increases the shear rate. After a period of time, the fluid deviates from its rotational path in pump housing 503 and exits an outlet pipe 505 of the pump. This deviation creates more shear rates in the fluid flow. These accumulated shear rates in the fluid flow enhance the mixing of the treating agents with the fluid and result in a homogeneous mixture which exits through a pump outlet 506. An electric motor (not shown) is connected to the pump via connecting shaft 412 and provides power for the pump. In alternate embodiments various differing power sources may be used to power the pump including, but not limited to, a gasoline motor, a crank, a steam or gas turbine, wind or flowing water on an external propeller, etc. It is to be understood that treating agents admixed with contaminated fluid may cause corrosion of the main/primary functional parts such as, but not limited to, impellers, suction inlet, and discharge outlet of the at least one high-energy pump-mixer. Therefore, to relatively, minimize corrosion of the primary functional parts, the construction material for the at least one high-energy pump-mixer may be comprised of, but is not limited to, high Nickel content stainless steel.

In the present embodiment, the mixing pump is able to provide positive head pressure and rapid and adjustable mixing of gaseous, liquid or solid treating agents into a contaminated flow stream. The rapid mixing of the pump enhances fast and diffusion-limited reaction kinetics such as, but not limited to, the ones of oxidative and/or catalytic processes performed by the treating agents. Furthermore, the high shear rates created by the pump are able to disaggregate contaminated particles while simultaneously delivering the treating agents to the particle core, as shown by way of example in FIG. 2. This is particularly useful for slurry phase fluid treatment such as, but not limited to, municipal and industrial wastewater sludge. Additionally, the pump according to the present embodiment may be used in a treatment system implementing the simultaneous application of conflicting treating agents since the rapid mixing promoted by the pump reduces process inefficiencies due to anti synergistic actions of the treating agents. The rapid mixing generally prevents the treating agents from coming into contact with each other before they are actually dispersed into the contaminated fluid. For example, without limitation, it is known to those skilled in the art that activated carbon quenches oxidants such as hydrogen peroxide and chlorine, however its quenching rate depends on the activated carbon and oxidant local concentrations; notably, such a rate can be significantly reduced by lowering their concentrations by dilution with the contaminated fluid using substantially rapid mixing.

Those skilled in the art, in light of the present teachings, will readily recognize that the pump described in the foregoing is for exemplary purposes and that various different types of pumps or pumps with different features may be used in alternate embodiments. For example, without limitation, direct lift, positive displacement pumps such as, but not limited to, gear pumps, progressing cavity pumps, roots-type pumps, peristaltic pumps, reciprocating-type pumps, compressed-air-powered double-diaphragm pumps, impulse pumps, hydraulic ram pumps, etc. may be used in some alternate embodiments. Some alternate embodiments may employ velocity pumps such as, but not limited to, centrifugal pumps, radial flow pumps, axial flow pumps, mixed flow pumps, eductor-jet pumps, etc. Density pumps, gravity pumps, or steam pumps may also be used in some alternate embodiments.

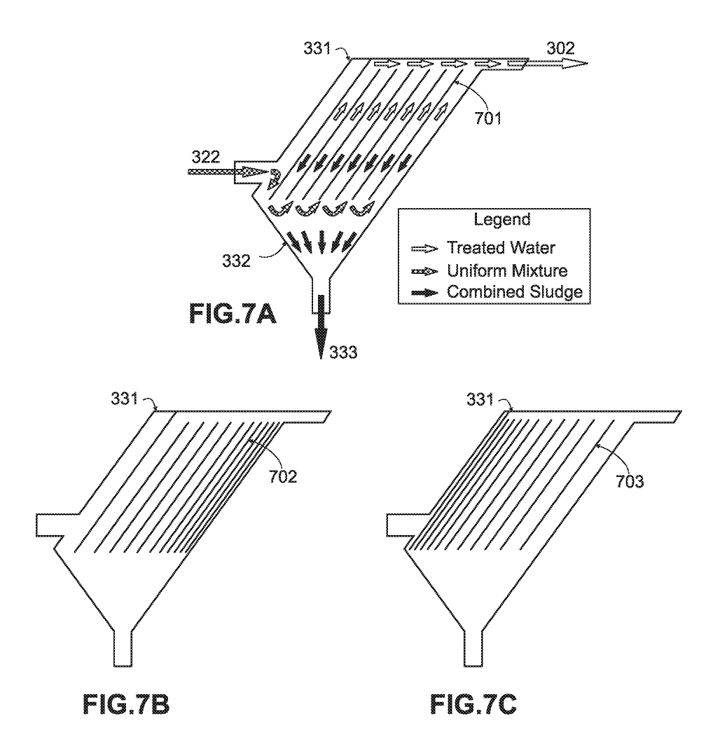

FIG. 6 illustrates a diagrammatic side view of an exemplary injector from a fluid treatment system, in accordance with an embodiment of the present invention. In the present embodiment, a treating agent enters an inlet 601 of the injector and flows through an inlet pipe 602 of the injector. In alternate embodiments, the injectors may be located on the main body of the pump rather than on a pipe or may be at a different depth in the fluid. The flow rate of the treating agent can be controlled by adjusting a handle 603 of an injector valve or may be assisted by an external metering pump. Alternatively, the treating agent may be pulled into the bulk fluid flow by the main pump of the system as the injectors are located in the suction zone of the system. The velocity of the treating agent increases in an injector nozzle 604 as the treating agents are introduced into the mainstream via an injector outlet 605. It is to be understood that the nozzles engaged in the operation for dispensing/injecting the treating agents to the body of the at least one high-energy pump-mixer may also cause corrosion of the construction material of the nozzles. Therefore, to relatively minimize corrosion of the construction material of the nozzles, the construction material for the nozzles may be comprise of, but not limited to, high Nickel content stainless steel.

Those skilled in the art, in light of the present teachings, will readily recognize that the injector described in the foregoing is for exemplary purposes and that various different types of injectors with different features may be used in alternate embodiments. For example, without limitation, other kind of injectors such as jets nozzles, high velocity nozzles, propelling nozzles, magnetic nozzles, spray nozzles, vacuum nozzles, or shaping nozzles as injectors can be used in alternate embodiments. Similarly, specially shaped injectors such as, but not limited to, L-shaped or angled injectors can be used for example, without limitation, to direct the treating agents towards a targeted region of the contaminated fluid or to generally prevent early mixing between the treating agents which may cause anti-synergistic action thus reducing the processing rates or generating conditions for local corrosion. In some alternate embodiments, treating agents can also be delivered to the contaminated fluid using a venturi injector as well as external metering pumps such as, but not limited to, small radial flow centrifugal pumps (i.e., booster pump), peristaltic pumps, membrane pumps, positive displacement pumps, etc.

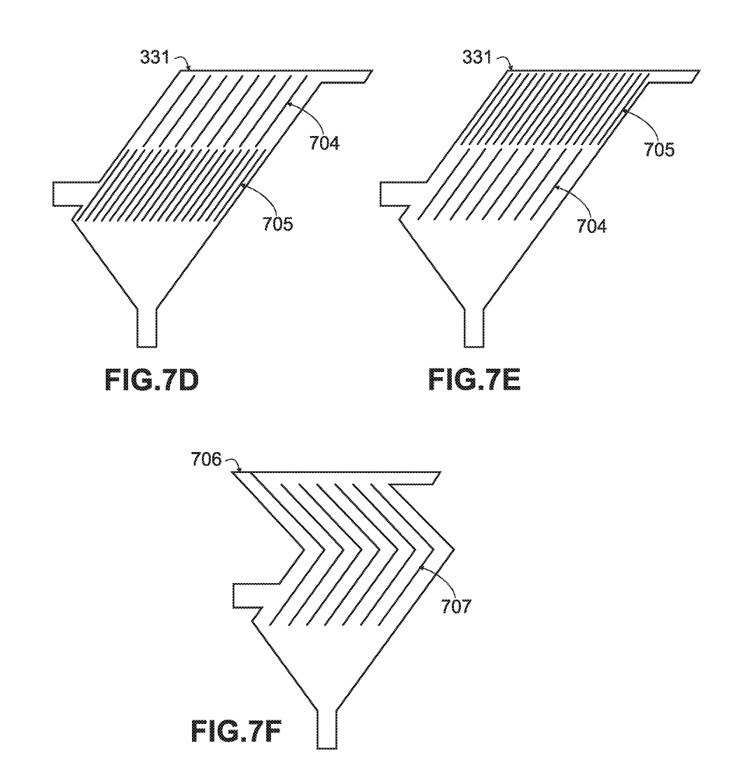

FIG. 7A-7F shows the flow of material through exemplary processing tank 331, in accordance with an embodiment of the present invention. In the present embodiment, mixture 322 comprising a fluid and treating agents enters processing tank 331. The flow of mixture 322 impinges to a parallel inclined plates portion 701 in processing tank 331 and enters a plate rack through side-entry plate slots. This crosscurrent entry method minimizes the risk of disturbing previously settled solids; however, different entry methods may be used in alternate embodiments. In the present embodiment, a small gap between parallel inclined plates portion 701 leads to a creeping laminar flow between parallel inclined plates portion 701, which produces enough time for the particle separation/settling and coagulation/absorption/disinfection/oxidation processes. Since the gap between parallel inclined plates portion 701 is narrow, mixture 322 flows between parallel inclined plates portion 701 slowly, and as mixture 322 flows upward, the solids settle on the parallel inclined plates portion 701 and slide into settling hopper 332 at the bottom of processing tank 331. Additionally, fluid particles gain an adequate treatment dose and contact time due to slow fluid motion between parallel inclined plates portion 701. The process residuals in the form of combined sludge 333 drains from the bottom of settling hopper 332. Finally, treated fluid 302 exits the top of processing tank 331.

Those skilled in the art, in light of the present teachings, will readily recognize that the horizontally uniform plate spacing lamella described in the foregoing is for exemplary purposes and that numerous plate spacing and plate configurations may be used in alternate embodiments to offer the flexibility needed to handle variations in effluent characteristics. For example, without limitation, horizontally non-uniform coarse to fine inclined plates (FIG. 7B), horizontally non-uniform fine to coarse inclined plates (FIG. 7C), vertically non-uniform fine to coarse inclined plates (FIG. 7D), vertically non-uniform coarse to fine inclined plates (FIG. 7E) and sherwood plates lamella (FIG. 7F) may be used in some alternate embodiments. By altering the plate spacing (to allow for different solids loading ratios, settling rates, etc.) lamella may be sized appropriately for specific application such as, but not limited to, water treatment system. The lamellas can be adjusted either manually or using a mechanical device, depending on the treatment objectives.

Those skilled in the art, in light of the present teachings, will readily recognize that the processing tanks described in the foregoing is for exemplary purposes and that various different types of separation techniques or processing tanks with different features, membranes, or filters may be used in alternate embodiments. For example, without limitation, a circular or rectangular clarifier, with or without baffles, may be utilized in which contaminated fluid fully mixed with treating agents supplied through a tangential or radial pipe injector causing fluid to lower its velocity such that particle settling is allowed. Centrifugal settlers such as, but not limited to, hydro-cyclones can also be used in alternate embodiments to enhance the separation process. In these embodiments, the fluid rotation creates a vortex, which imparts centrifugal forces onto any solid particles within the fluid. These centrifugal forces move the particles away from the center of the tank, thus leaving a relatively clean fluid at the center. Similarly, a serpentine-like tank may be used in some alternate embodiments to increase the residence time and produce low speed flow, leading to separation of solid particles from the fluid stream. In addition, alternate physical, mechanical, chemical and biological separation processes can be used in alternate embodiments of the present invention. For example, without limitation, granular filters such as, but not limited to, sand and carbon filters, membrane filters such as, but not limited to, microfiltration, ultrafiltration and nanofiltration systems, magnetic separators, or hydrocyclones can be used in alternate embodiments to remove the delivered treating agents in their solid, liquid and gaseous state from the contaminated fluids.

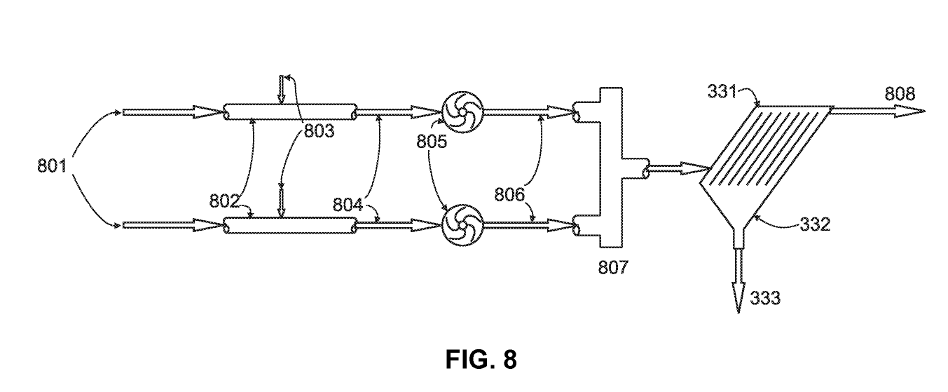

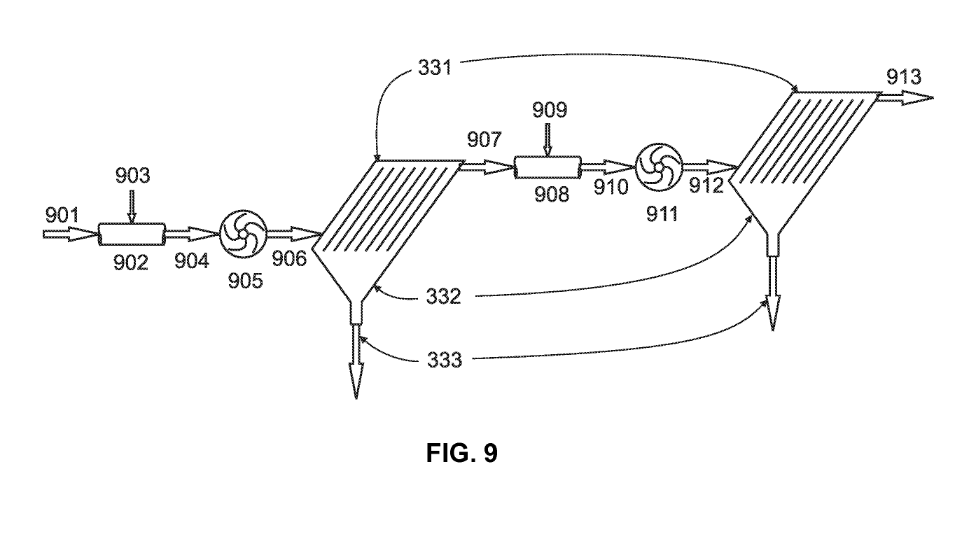

The mixing method for many embodiments of the present invention may be used in different configurations for easy integration into various types of systems. For example, without limitation, parallel and series configurations of mixing are illustrated by way of example in FIGS. 8 and 9. In other alternate embodiments, different types of mixing methods may be used such as, but not limited to, a method using a combination of the parallel and series configurations. Fluid treatment systems according to many embodiments of the present invention can be designed for any mixing gradient and mixing time by placing pumps in series or parallel and/or by adjusting the rotor speed of the pump or the pump geometry. For example, without limitation, by using multiple pumps in series and/or parallel, many embodiments enable treating agents to be mixed into the fluid flow in prescribed sequences, and is a helpful attribute in many treatment processes involving multiple treating agents that is not easily accomplished with prior art methods.

FIG. 8 shows an exemplary hydraulic configuration for an integrated treatment system where a pumps portion 805 and two injectors modules are used in parallel, in accordance with an embodiment of the present invention. As a non-limiting example, pumps portion 805 may be two pumps. This style is useful especially with high flow rates or cases where two or more treating agents need to be pre-mixed before another treating agent is delivered into the fluid. In the present embodiment, an untreated fluid 801 enters a suction pipes portion 802 where a treating agents portion 803 is injected into the fluid flow. A mixture 804 of the treating agents and untreated fluid 801 enters pumps portion 805 to be mixed completely while being pumped. A mixed fluid 806 enters a collector 807 and is introduced into processing tank 331 where combined sludge 333 drains from the bottom of settling hopper 332. A treated fluid 808 exits the top of processing tank 331. More than two pumps or injectors may be used in this mode in alternate embodiments.

FIG. 9 illustrates an exemplary hydraulic configuration for an integrated treatment system where a pump 905 and a pump 911 are used in series, in accordance with an embodiment of the present invention. This configuration may be used when treatment processes need to be carried out in a certain sequence. In the present embodiment, an untreated fluid 901 enters a first suction pipe 902 and a first treating agent 903 is injected into the fluid flow. A mixture 904 of untreated fluid 901 and first treating agent 903 are mixed by a first pump 905. Once mixture 904 becomes a homogenized mixture 906 of first treating agent 903 and untreated fluid 901, homogenized mixture 906 enters processing tank 331 and sludge 333 of the first treatment is drained from the bottom of settling hopper 332. A partially treated fluid 907 enters a second suction pipe 908. A second treating agent 909 is introduced to the main stream and a mixture 910 of partially treated fluid 907 and second treating agent 909 is mixed via a second pump 911. Then, once mixture 910 becomes a uniform mixture 912, uniform mixture 912 flows into processing tank 331 where sludge 333 is removed from the bottom of settling hopper 332 and a treated fluid 913 exits from the top of processing tank 331. More than two pumps, injectors or processing tanks may be used in this arrangement in alternate embodiments. In another alternate embodiment, multiple pumps and injectors may be placed in series before a single processing tank.

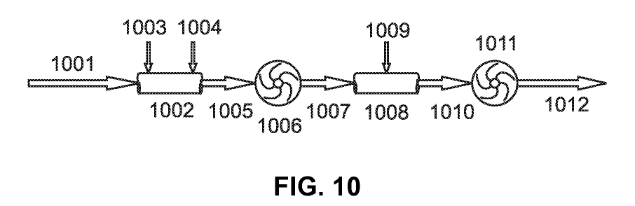

FIG. 10 illustrates an exemplary hydraulic configuration for an integrated treatment system with a first pump 1006 and a second pump 1011 in series, in accordance with an embodiment of the present invention. In the present embodiment two treating agents, a first treating agent 1003 and a second treating agent 1004, are first premixed and then a third treating agent 1009 is added to the mixture. An untreated fluid 1001 enters a first suction pipe 1002 and first treating agent 1003 and second treating agent 1004 are injected into the fluid flow. A mixture 1005 of untreated fluid 1001, first treating agent 1003 and second treating agent 1004 are mixed by first pump 1006. Once mixture 1005 becomes a homogenized mixture 1007, it enters a second suction pipe 1008 where third treating agent 1009 is introduced into the main stream and a mixture 1010 of homogenized mixture 1007 and third treating agent 1009 is well mixed via second pump 1011. Then, once mixture 1010 becomes a uniform mixture 1012, uniform mixture 1012 enters the next stage in the treatment process, for example, without limitation, an integrated coagulation/adsorption/oxidation stage.

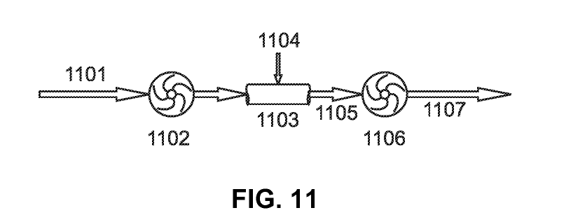

FIG. 11 illustrates an exemplary use of an integrated fluid treatment system for chemigation purposes, in accordance with an embodiment of the present invention. The present embodiment may be used to improve the chemigation process where the risk of groundwater or water resource pollution needs to be minimized. Chemigation is the process of delivering a fertilizer in agriculture. In the chemigation process, various chemical components such as, but not limited to, fertilizers or pesticides are mixed with the irrigation water. The chemigation process produces a uniform mixture while avoiding water resource pollution. In the present embodiment, a water portion 1101 is pulled into a first pump 1102 and then flows through a pipe 1103 where a treating agent 1104 is injected into water portion 1101. A mixture 1105 of treating agent 1104 and water portion 1101 then enters a second pump 1106, and a mixed fluid 1107 exits second pump 1106. Treating agent 1104 is injected after first pump 1102 is turned on. Thus, first pump 1102 generally prevents the escape of treating agent 1104 through the inlet of the system and the penetration of treating agent 1104 into the water resource. Second pump 1106 aids fluid flow and enhances the mixing of water portion 1101 with treating agent 1104.

The effects of the pump speed on the mixing of treating agents, numerical simulation and computations performed for different impeller angular velocities in an exemplary integrated fluid treatment system are shown by way of example in FIG. 4. Three cases with different pump angular velocities (i.e., 750 rpm, 1500 rpm and 3000 rpm) that lead to three different flow rates (i.e., 1.68 lit/s, 3.36 lit/s and 6.73 lit/s) are investigated. In the example cases, aluminum polychloride, carbon particles and NaClO were injected as model coagulant, adsorbent and disinfectant, respectively. The parameter “G” (e.g. the mixing gradient), obtained by the following equation, can represent the performance of mixing:

$$G = \frac{{μ}_{t}}{μ} \sqrt{2 {\sum }_{i} {( \frac{\partial {u}_{i}}{\partial {x}_{i}} )}^{2} + {\sum }_{i , j} {[ \frac{\partial {u}_{i}}{\partial {x}_{j}} + \frac{\partial {u}_{j}}{\partial {x}_{i}} ]}^{2}} \qquad ) 1 ($$

A flow scenario that produces a larger value for G results in improved mixing of the existing treating agents in the fluid flow. For incompressible fluid flow, the first term in the above equation (∂uᵢ/∂xᵢ) is zero due to the continuity equation, and thus G is reduced to the following equation:

$$G = \frac{{μ}_{t}}{μ} \sqrt{{\sum }_{i , j} {[ \frac{\partial {u}_{i}}{\partial {x}_{j}} + \frac{\partial {u}_{j}}{\partial {x}_{i}} ]}^{2}} = \frac{{μ}_{t}}{μ} \sqrt{{S}_{ij} {S}_{ij}} \qquad ) 2 ($$

where Sᵢⱼ=∂uᵢ/∂xⱼ+∂uⱼ/∂xᵢ is the strain rate and \sqrt{SᵢⱼSᵢⱼ} the strain rate magnitude.
Thus, the G parameter is calculated by the following equation:

$$G = \frac{{μ}_{t}}{μ} \times ( strain rate magnitude ) \qquad ) 3 ($$

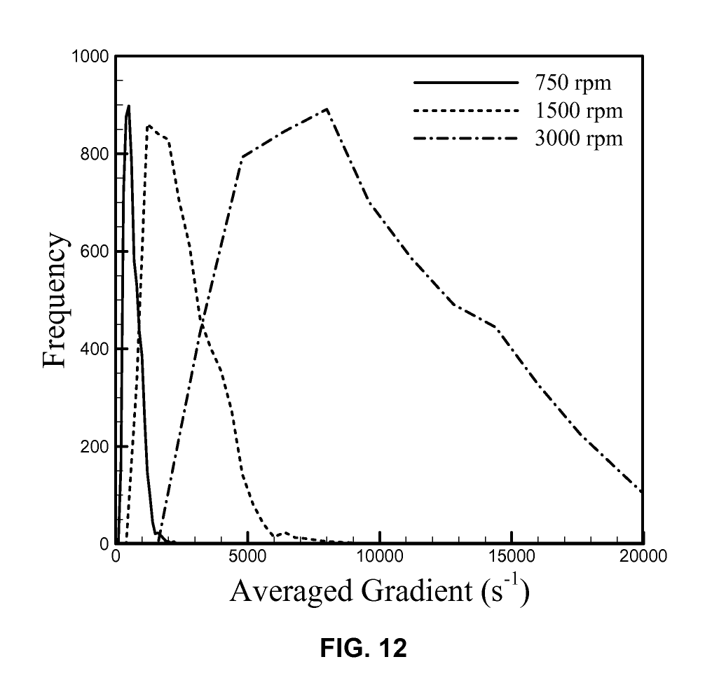

FIG. 12 is a chart showing exemplary averaged velocity gradients (G parameter) for different rotational speeds of a mixing pump from an exemplary integrated fluid treatment system, in accordance with an embodiment of the present invention. A statistically significant number of fluid particles (>6000) mimicking the contaminated fluid are injected at the inlet to investigate the averaged velocity gradients (G parameter). The number of fluid particles experiencing the same gradient (i.e., frequency) is plotted against the G parameter. The distribution of averaged G shows that increasing the pump angular velocity increases the averaged G experienced by fluid particles. Therefore, higher angular velocity results in improved mixing. This demonstrates that the G parameter can be controlled by varying the angular velocity of the pump. For example, without limitation, when the pump angular velocity exceeds 3000 rpm, the average G experienced by the fluid particles exceeds 9074 s⁻¹, that is, almost an order of magnitude greater than the design value of 700 to 1000 s⁻¹ commonly used to size rapid mixing units using blade mixers.

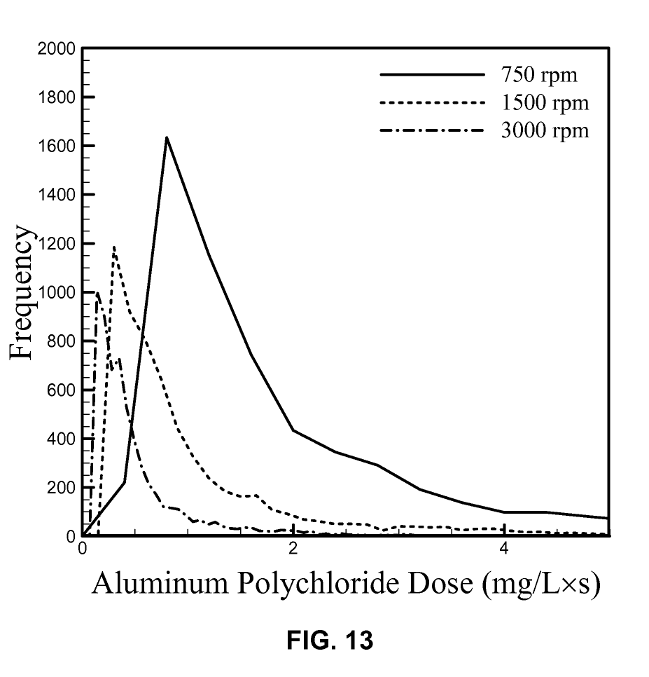

FIG. 13 is a graph showing exemplary effects of the rotational speed of a mixing pump on the coagulant dose in an exemplary integrated fluid treatment system, in accordance with an embodiment of the present invention. The number of fluid particles experiencing the same gradient (i.e., frequency) is plotted against the coagulant dose. In the present example, aluminum polychloride is used as the coagulant; however, various different coagulants may be used in alternate embodiments such as, but not limited to, aluminum hydroxide, iron (III) hydroxide, ferric chloride, ferrates, persulfates, any other positively or negatively charged anions and polyelectrolytes, and any combinations of the above.

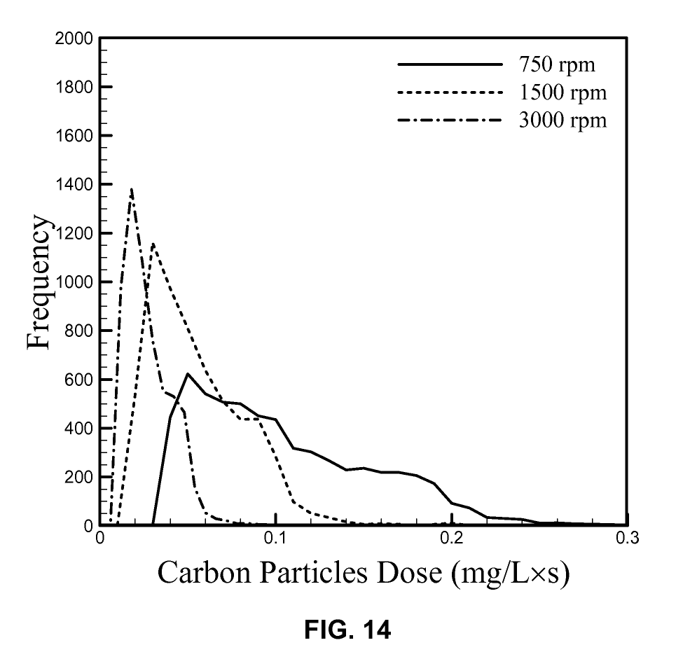

FIG. 14 is a graph showing exemplary effects of the rotational speed of a mixing pump on the adsorbent dose in an exemplary integrated fluid treatment system, in accordance with an embodiment of the present invention. The number of fluid particles experiencing the same gradient (i.e., frequency) is plotted against the adsorbent dose. In the present example, carbon particles are used as the adsorbent; however, various different natural or synthetic materials may be used as an absorbent or super-absorbents in alternate embodiments such as, but not limited to, natural and synthetic zeolites, biological flocs and synthetically manufactured adsorbents (polymers). Also, organic and inorganic catalysts such as, but not limited to, magnetite and titanium oxides can be used as absorbents in heterogeneous fenton or photofenton like processes.

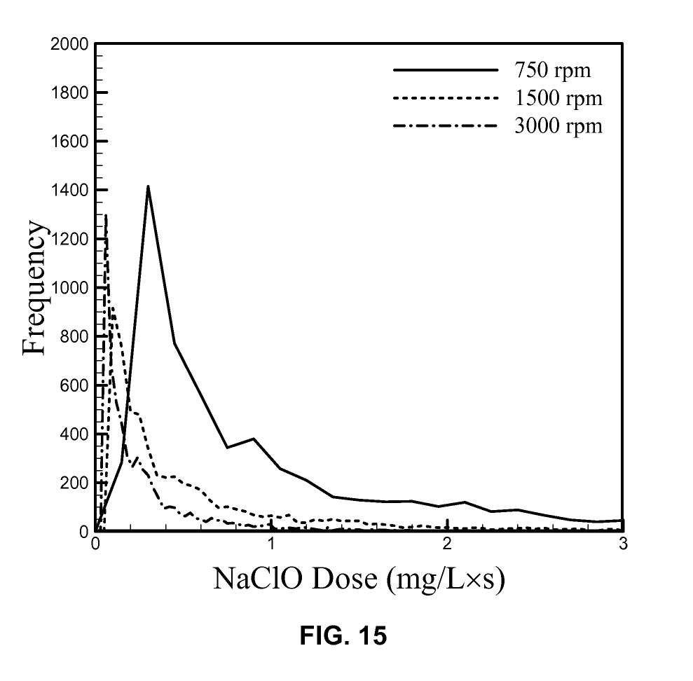

FIG. 15 is a graph showing exemplary effects of the rotational speed of a mixing pump on the disinfectant dose in an exemplary integrated fluid treatment system, in accordance with an embodiment of the present invention. The number of fluid particles experiencing the same gradient (i.e., frequency) is plotted against the disinfectant dose. In the present example, NaClO is used as the disinfectant; however, different disinfectants may be used in alternate embodiments such as, but not limited to, ozone, peracetic acid, potassium permanganate, hydrogen peroxide, ferrates, performic acid, chlorine dioxide and other organic and inorganic acids.

Referring to FIGS. 13 through 15, by increasing the pump angular velocity, the flow rate of the fluid increases and thus the resident time of the particles decreases. Here the residence time represents the average amount of time that particles spend in the system. Although in these exemplary cases the concentration of the treating agents is the same, smaller resident time for greater pump angular velocity leads to a smaller average dose of the treating agents.

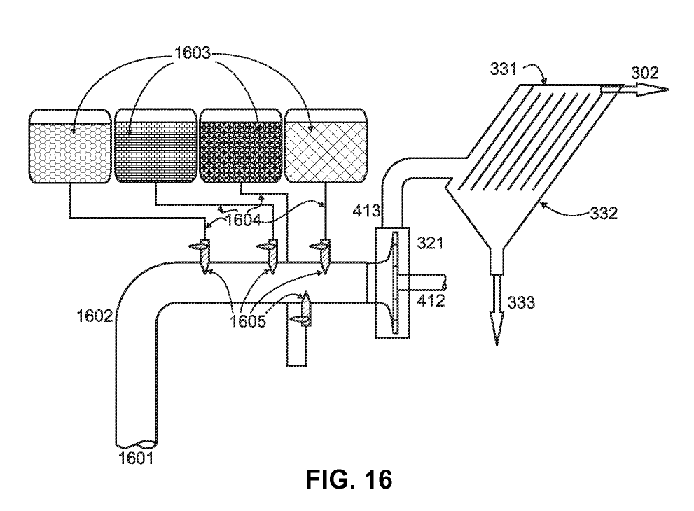

FIG. 16 is a schematic representation of an exemplary pilot plant, in accordance with an embodiment of the present invention. To investigate the performance of an integrated fluid treatment system, several experimental trials were carried out using the pilot plant. In this pilot plant, untreated water enters an inlet 1601 of a suction pipe 1602 where four treating agents 1603 are introduced into the flow via four injectors 1605. As a non-limiting example, suction pipe 1602 may be 80 mm in diameter. Treating agents 1603 are delivered to injectors 1605 by a flexible tubes portion 1604. As a non-limiting example flexible tubes portion 1604 may be four separate tubes. The mixture of the fluid and treating agents 1603 enters centrifugal fluid pump 321, powered by connecting shaft 412 connected to an electrical motor. Fluid pump 321 mixes the fluid and treating agents 1603. The mixed fluid then exits outlet 413 of fluid pump 321 and enters processing tank 331. Combined sludge 333 is removed from the bottom of settling hopper 332 and treated fluid 302 leaves the pilot plant from the top of processing tank 331.

A number of experiments have been designed and carried out in order to estimate the treatment efficiency of this exemplary system in terms of chemical oxygen demand (COD) removal, coliform inactivation and sludge production. Four injectors are used in the present embodiment in order to deliver a known amount of coagulant, adsorbent, and disinfectant; however, fewer or more injectors may be used in alternate embodiments. In testing of the present embodiment, the following treating agents were tested: polyaluminium chloride (0-150 μL/L), powder activated carbon (0-30 mg/L), sodium hypochlorite (0-7.5 mg/L), and micronized zeolite (0-150 mg/L). Those skilled in the art, in light of the present teachings, will readily recognize that various different treating agents may be used in alternate embodiments. Table 1 summarizes the combinations tested in the present embodiment, designed according to a well-known statistical technique (e.g. orthogonal Latin square).

TABLE 1

| Combination | Polyaluminium | Activated | Sodium | Natural |
|---|---|---|---|---|
| # | Chloride | Carbon | Hypochlorite | Zeolite |
| 01 | 0 | 20 | 0 | 0 |
| 02 | 50 | 30 | 0 | 0 |
| 03 | 100 | 10 | 5 | 0 |
| 04 | 150 | 0 | 5 | 0 |
| 05 | 0 | 10 | 2.5 | 50 |
| 06 | 50 | 0 | 2.5 | 50 |
| 07 | 100 | 30 | 7.5 | 50 |
| 08 | 150 | 20 | 7.5 | 50 |
| 09 | 0 | 0 | 7.5 | 100 |
| 10 | 50 | 10 | 7.5 | 100 |
| 11 | 0 | 30 | 5 | 150 |
| 12 | 50 | 20 | 5 | 150 |
| 13 | 100 | 20 | 2.5 | 100 |
| 14 | 150 | 30 | 2.5 | 100 |
| 15 | 150 | 10 | 0 | 150 |
| 16 | 100 | 0 | 0 | 150 |

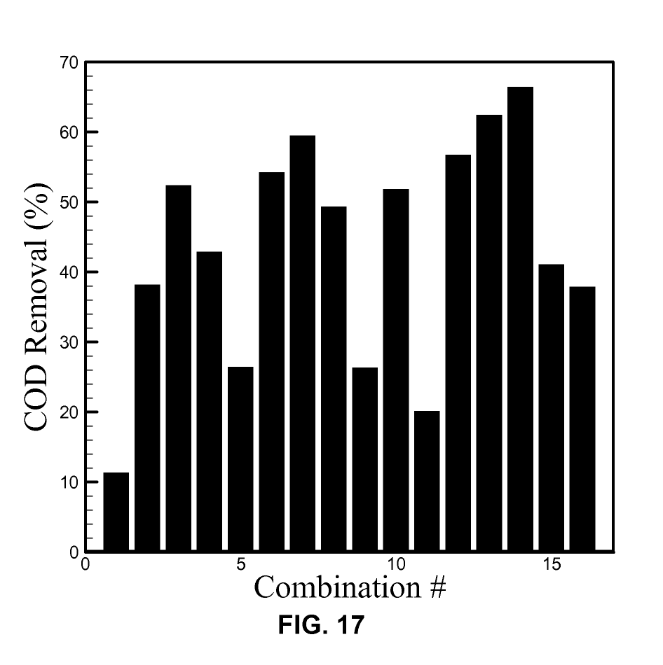

FIG. 17 illustrates the COD removal obtained in tested experimental trials of the pilot plant illustrated by way of example in FIG. 16, in accordance with an embodiment of the present invention.

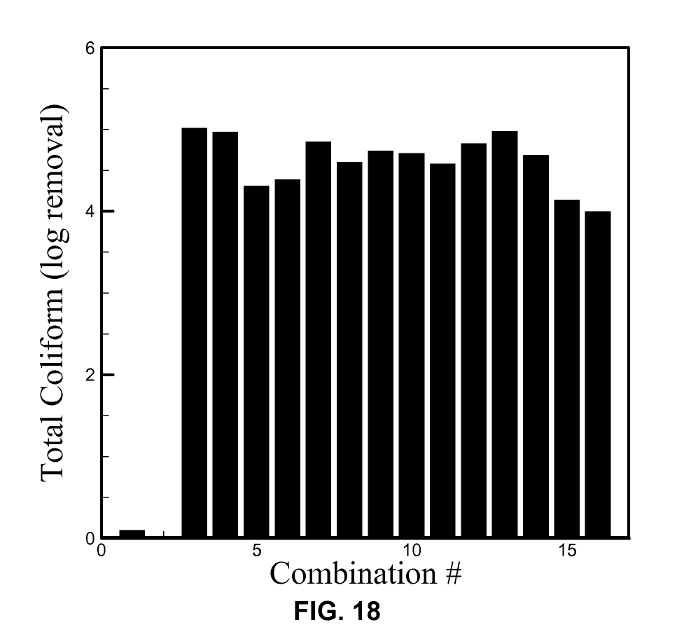

FIG. 18 displays the coliform inactivation obtained in tested experimental trials of the pilot plant illustrated by way of example in FIG. 16, in accordance with an embodiment of the present invention.

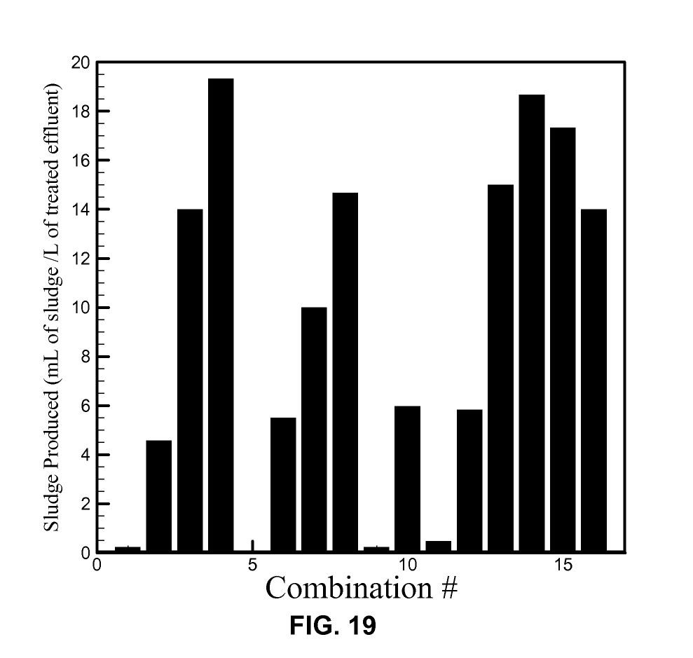

FIG. 19 shows the sludge production obtained in tested experimental trials of the pilot plant illustrated by way of example in FIG. 16, in accordance with an embodiment of the present invention.

Referring to FIGS. 17 through 19, combinations of concentrations of coagulant (i.e., poly aluminum chloride), adsorbent (i.e., activated carbon), disinfectant (i.e., sodium hypochlorite) and ion scavenger and adsorbent (i.e., natural zeolite) were tested in triplicate. The measured variables were COD [mg/L O₂], microbial concentration of total coliform, and sludge volume. The mean and the standard deviation as observed during the experiments are shown. Notably, combination #13 provided excellent results with a 62% COD removal efficiency, 5 log total coliform inactivation and a sludge volume production as low as 15 mL sludge/L. Combination #13 is also effective in removing micropollutants from wastewater such as phenols with average removal in the order of 50-70%.

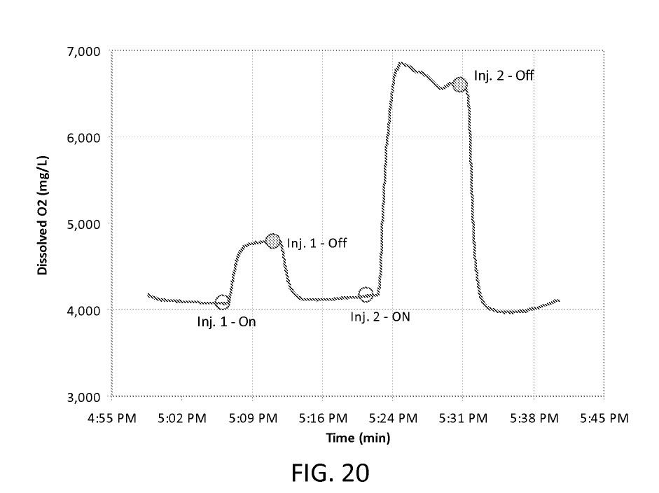

FIG. 20 shows changes in dissolved gas concentration obtained in tested experimental trials of the pilot plant when a gaseous treating agent is injected in the contaminated fluid, illustrated by way of example in FIG. 16, in accordance with an embodiment of the present invention. In this exemplary demonstration, when ambient air is injected as gaseous treating agent, the contaminated fluid dissolved oxygen concentration increases rapidly (up to 8 mg/L). It can be noticed that the dissolved oxygen concentration rapidly returns to background values (4 mg/L) when the injectors are turned OFF.

Those skilled in the art, in light of the present teachings, will readily recognize that the pump-mixer described in the foregoing is for exemplary purposes and that various different types of pumps or pumps with different features may be used in alternate embodiments. For example, without limitation, direct lift, positive displacement pumps such as, but not limited to, gear pumps, progressing cavity pumps, roots-type pumps, peristaltic pumps, reciprocating-type pumps, compressed-air-powered double-diaphragm pumps, impulse pumps, hydraulic ram pumps, etc. may be used in some alternate embodiments. Some alternate embodiments may employ velocity pumps such as, but not limited to, centrifugal pumps, radial flow pumps, axial flow pumps, mixed flow pumps, eductor-jet pumps, etc. Density pumps, gravity pumps, or steam pumps may also be used in some alternate embodiments.

Having fully described at least one embodiment of the present invention, other equivalent or alternative methods of providing an integrated fluid treatment system according to the present invention will be apparent to those skilled in the art. The invention has been described above by way of illustration, and the specific embodiments disclosed are not intended to limit the invention to the particular forms disclosed. For example, the particular implementation of the system may vary depending upon the particular type of application for which it is to be used. The systems described in the foregoing were directed to fluid treatment implementations; however, similar techniques are to use the integrated system for other types of chemical processes such as, but not limited, to, manufacturing processes, refining processes, food processing, etc. Non-fluid treatment implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

We claim:

1. A method comprising the steps of:
transporting a contaminated fluid and at least one treating agent into a processing tank by way of at least one pump-mixer;
rapidly and vigorously mixing of said contaminated fluid and said at least one treating agent by said at least one pump-mixer;
in an integrated processing tank, treating contaminants from said contaminated fluid and separating process residuals in form of sludge in said processing tank, and
extracting said sludge from a treated fluid from said processing tank.

2. The method of claim 1, in which said at least one treating agent is dispensed into a suction pipe through at least one injection nozzle, and wherein substantially mixing of said at least one treating agent into said contaminated fluid forms a mixture within said suction pipe before said mixture is fed to said at least one pump-mixer from said suction pipe.

3. The method of claim 2, in which dispensing of said at least one treating agent is regulated with an automated metering system, and wherein said automated metering system substantially regulates desired volume of said treating agents to be dispensed

4. The method of claim 1, wherein said rapid and vigorous mixing substantially mix the treating agent and the contaminated fluid as well as it disaggregates relatively larger cluster of particles into relatively smaller size particles, and wherein said smaller size particles in-conjunction with said at least one treating agent substantially enhances said processing rate.

5. The method of claim 4, in which operationally enabling said at least one pump-mixer generates relatively higher shear stresses, and wherein said relatively higher shear stresses are instrumental in an effective delivery of said at least one treating agent into core of said larger cluster of particles to further enhance said processing rate.

6. The method of claim 1, wherein said contaminated fluid comprises a liquid, a gas, a solid, a slurry phase fluid, or sludge, and wherein said slurry phase fluid or said municipal sludge are effectively treated by said high shear stresses.

7. The method of claim 1, wherein said at least one pump-mixer acts as a relatively higher surface-to-volume ratio reactor, wherein said relatively higher surface-to-volume ratio reactor yields substantially higher mixing rate for said contaminated fluid and said at least one treating agent, and wherein said substantially higher mixing rate of said contaminated fluid and said at least one treating agent further enhances said processing rate.

8. The method of claim 1, wherein said at least one treating agent further comprises at least one conflicting treating agent, and wherein said rapid and vigorous mixing facilitates simultaneous application of said at least one conflicting treating agent by effectively minimizing anti-synergistic reactions between said at least one conflicting treating agent and the remaining treating agents.

9. The method of claim 1, further comprising the step of using ultrasonic wave energy to accelerate the processing rate for treating said contaminated fluid, wherein said ultrasonic wave energy is generated by way of an ultrasonic treatment mechanism configured to said processing tank.

10. The method of claim 1, further comprising the step(s) of simultaneously performing coagulation, adsorption, disinfection, and/or oxidization of said contaminated fluid in said processing tank.

11. The method of claim 1, wherein said rapid and vigorous mixing of said contaminated fluid is achieved by operationally enabling at least one said at least one pump-mixer installed in parallel.

12. The method of claim 1, in which at least two of said at least one pump-mixer are installed in series, and said rapid and vigorous mixing of said contaminated fluid is achieved by at least one of said at least one pump-mixers installed in series.

13. The method of claim 12, in which at least two of said at least one pump-mixer are installed in parallel, and said rapid and vigorous mixing of said contaminated fluid is achieved by essentially adjusting rotor speed of at least one of said at least one pump-mixers installed in parallel.

14. The method of claim 13, wherein said rapid and vigorous mixing of said contaminated fluid is achieved by essentially adjusting rotor speed for at least one of said at least one pump-mixers installed in series.

15. A system comprising:
at least one pump-mixer configured to be operable for mixing contaminated fluid and at least one treating agent, said at least one at least one pump-mixer being further configured with a suction pipe, wherein said suction pipe is removably joined to said at least one at least one pump-mixer, and said suction pipe is configured to receive at least one injector, wherein said at least one injector is removably joined to said suction pipe, wherein said at least one injector is configured to dispense said at least one treating agent into said suction pipe, wherein said suction pipe is further configured to receive an incoming flow stream of said contaminated fluid;
at least one processing tank configure for treating said contaminated fluid to process a treated fluid;
at least one settling tank configured to be operable for settling contaminants from said contaminated fluid;
at least one separation unit configured to be operable for separating sludge from treated unit;
said at least one processing tank being further configured to mix said at least one treating agent and said contaminated fluid;
said at least one processing tank being further configured to be operable to treat contaminants from said contaminated fluid; and
said at least one separation unit being further configured to separate process residuals such as sludge from said treated fluid.

16. The system of claim 15, in which separation of said sludge from said treated fluid is conducted within a separation unit, wherein said separation unit comprises at least one lamella clarifier, ceramic filter, and hydro-cyclone processing components to be engaged for treating said contaminated fluid.

17. The system of claim 16, in which said separation unit is configured to disinfect said contaminated fluid in said processing tank.

18. The system of claim 17, wherein said separation unit is configured to further simultaneously perform coagulation, adsorption and/or oxidization of said contaminated fluid.

19. The system of claim 15, in which said at least one pump-mixer is configured to have at least at least one dispending nozzle, wherein said at least one dispending nozzle is removably attached to a suction pipe, wherein said suction pipe is removeably attached to said at least one pump-mixer, and wherein said suction pipe serves as a mixing chamber for mixing said treating agents into said contaminated fluid.

20. The system of claim 15, wherein said at least one pump-mixer is configured to operationally perform mixing of said at least one treating agent into said contaminated fluid in a prescribed sequence-mixing, and wherein said prescribed sequence-mixing comprises; (a+b) with first said at least one pump-mixer, and then c to already mixed said (a+b) with second said at least one pump-mixer.

21. A system comprising:
at least one integrated pump-mixer configured to be operable for mixing contaminated fluid and at least one treating agent, wherein construction material for said at least one pump-mixer comprises a high Nickel contents stainless steel, wherein if more that two pump-mixers are present, at least two of said at least two pump-mixers being configured in parallel, said at least one at least one pump-mixer being further configured with a suction pipe, wherein said suction pipe is removably joined to said at least one at least one pump-mixer, said suction pipe being further configured to receive at least one injector, wherein construction material for said at least one injector comprises a high Nickel contents stainless steel, wherein said at least one injector is removably joined to said suction pipe, and said at least one injector is further configured to dispense said treating agents into said suction pipe, wherein said suction pipe is further configured to receive an incoming flow stream of said contaminated fluid, and wherein said at least one treating agent and said contaminated fluid are mixed inside said suction pipe prior to being fed to said at least one at least one pump-mixer;
at least one processing tank configure for treating said contaminated fluid to process a treated fluid;
at least one processing tank configured to be operable for settling contaminants from said contaminated fluid;
at least one separation unit configured to be operable for separating sludge from treated unit;
said at least one processing tank being further configured with a heating mechanism for treating said contaminated fluid, wherein heating mechanism is further configured for adapting operationally enabling means for said heating mechanism;
said at least one processing tank being further configured to rapidly and vigorously mix of said treating agents and said contaminated fluid;
said at least one processing tank being further configured to be operable to coagulate contaminants from said contaminated fluid;
said at least one processing tank being further configured to settle the contaminants; and
said at least one separation unit being further configured to separate sludge from treated liquid, wherein said at least one separation unit is further configured to disinfect said treated liquid.

22. A system comprising:
means for transporting a contaminated fluid and at least one treating agent into a processing tank using at least one pump-mixer;
means for mixing of said contaminated fluid and said at least one treating agent by said at least one pump-mixer in said processing tank;
means for treating contaminants from said contaminated fluid in said processing tank;
means for settling said contaminants in form of sludge in a settling tank; and
means for separating said sludge from a treated fluid from said settling tank.

23. The system of claim 15, further comprising a self regulating treating agent dosing system where the amount of each treating agent delivered to the fluid and the mixing gradient is self-adjusted by way of a suction effect induced by the pump-mixer, the interconnecting piping, the valves and nozzle geometry.
